(19) United States
(12) Patent Application Publication
(10) Pub. No.: US 2025/0354336 A1
(43) Pub. Date: Nov. 20, 2025

(54) Internal Spraying of Paper Product Cores

(71) Applicant: Kimberly-Clark Worldwide, Inc., Neenah, WI (US)

(72) Inventor: Riccardo Tagnin, Genova (IT)

(21) Appl. No.: 19/100,601

(22) PCT Filed: Aug. 12, 2022
(86) PCT No.: PCT/US2022/040198

§ 371 Date: Feb. 3, 2025

(51) Int. Cl. D21H 27/00; D21H 21/14; D21H 23/50; D21H 23/78; D21H 25/00

(52) U.S. Cl. CPC D21H 27/002; D21H 21/14; D21H 23/50; D21H 23/78; D21H 25/005

(57) ABSTRACT

An apparatus for producing tubes comprises a mandrel, a winding unit, and a fluid dispensing unit. The tube is formed as the winding unit winds at least one strip of web material around the mandrel and advances the tube along the mandrel toward a distal end of the mandrel. The fluid dispensing unit is disposed at the distal end of the mandrel and is configured to dispense a fluid to the inner surface of the tube as it advances past the distal end of the mandrel.

### BACKGROUND

Many tissue products, such as bath tissues and paper towels, are manufactured and sold as spirally wound rolls. Typically, the tissue product is wound on a tubular core that is made from a rigid paperboard material. The tubular core is useful since it allows for the product to be dispensed from a holder that is inserted through the tubular core. Bath tissue holders, for instance, typically include a spindle that extends through the hollow core. Once placed on the spindle, the bath tissue roll can be easily unwound and used by the consumer.

Some consumers prefer tissue products that emit a pleasant fragrance. In this regard, fragrances are commonly added to tissue products. The fragrances can be added to the finished product base sheet but are most frequently added to the core to minimize product safety risks and because scented cores provide a good spread of the scent. For example, the fragrance can be sprayed onto the rigid paperboard before it is formed into a core so that it will end up on either the inner surface of the core or the outer surface of the core. When applied to the inner surface, there is no tissue product covering the fragrance, so it can spread efficiently throughout the environment. However, fragrances are volatile by nature, so the persistence of smell on the core is short after opening the packaging. Alternatively, when applied to the outer surface of the core, the smell spreads more slowly but not very efficiently through the environment, as it is contained by the tissue product. As such, there is a need to produce an improved tissue product with a scented core.

### SUMMARY

In general, the present disclosure is directed to an apparatus for producing tubes. The apparatus comprises a mandrel, a winding unit, and a fluid dispensing unit. The tube is formed as the winding unit winds at least one strip of web material around the mandrel and advances the tube along the mandrel toward a distal end of the mandrel. The fluid dispensing unit is disposed at the distal end of the mandrel and is configured to dispense a fluid to the inner surface of the tube as it advances past the distal end of the mandrel.

After the tube is advanced past the distal end of the mandrel and fluid has been applied to its inner surface, it can be cut by a cutting unit located downstream from the fluid dispensing unit. As used herein, downstream means the direction in which the tube travels as it is formed.

In one embodiment, the fluid dispensing unit is a nozzle which dispenses the fluid in a conical pattern so as to apply the fluid uniformly on the inner surface of the tube as the tube travels over the nozzle.

In one embodiment, the fluid contains a suspension of microcapsules containing an active ingredient, such as a fragrance, an essential oil, an odor control agent, or an antimicrobial agent. The microcapsules can be carried by a liquid, which can be propelled by a pressurized gas. Alternatively, the nozzle can spray the active ingredient, such as a fragrance, directly onto the inner surface of the tube without the use of microcapsules.

In order to provide the fluid to the fluid dispensing unit, the apparatus can include one or more pipes which run through the interior of the mandrel and connect the fluid dispensing apparatus to a liquid reservoir and/or a compressed gas reservoir.

The present disclosure is also directed to a process for forming a tube using the apparatus. The process comprises applying an adhesive to a strip of the web material, winding the strip of web material onto the mandrel in a spiral configuration to form a tube extending longitudinally along the mandrel, causing the tube to advance along the mandrel toward a distal end of the mandrel, and applying a fluid to an inner surface of the tube by a fluid dispensing unit disposed at the distal end of the mandrel.

Following the application of the fluid, the process can further include cutting the tube downstream from the fluid dispensing unit to form a core and winding a tissue product onto the core. The tissue product can be a bath tissue or paper towel product.

In one embodiment, the process comprises winding only a single web strip to form the tube. In other embodiments, the process comprises winding two or more strips of webs to form the tube.

### BRIEF DESCRIPTION OF THE DRAWINGS

A full and enabling disclosure of the present invention, including the best or preferred mode thereof, directed to one of ordinary skill in the art, is set forth more particularly in the remainder of the specification, which makes reference to the appended figure in which:

FIG. 1 is a perspective view of an embodiment of a tube forming apparatus in accordance with the present disclosure;

FIGS. 2a-2d are cross-sectional views of various embodiments of mandrels and nozzles made in accordance with the present disclosure;

FIG. 3 is a sectional view of an embodiment of a mandrel and nozzle spraying a tube in accordance with the present disclosure;

FIG. 4 is a nozzle made in accordance with the present disclosure;

FIG. 5 is a perspective view of a tube forming apparatus for forming a single layer tube in accordance with the present disclosure;

FIG. 6 is a perspective view of a tube forming apparatus for forming a two layer tube in accordance with the present disclosure; and

FIG. 7 is a perspective view of a tissue roll formed in accordance with the present disclosure.

Repeat use of reference characters in the present specification and drawings is intended to represent same or analogous features or elements of the invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to the production of cores for tissue products, such as bath tissues and paper towels. Specifically, an apparatus for forming tubes and spraying them internally with a fluid is disclosed. The apparatus is particularly advantageous for producing cores containing microencapsulated active ingredients dispersed on the interior of the core.

The use of microcapsules prevents volatile active ingredients, such as fragrances, from evaporating too quickly after the product packaging is opened. For example, the microcapsules can contain the active ingredient until they are ruptured, ideally by the force between the interior of the core and a roll holder as the tissue product roll is unrolled.

However, microcapsules cannot just be sprayed onto the paperboard strips that will be used to form the core before they are wound because the strong shear caused by the winding belts pressing the paperboard against the winding mandrel would destroy the fragile capsules. As such, the active ingredient would be released during manufacturing and there would be few, if any, microcapsules left to rupture by the much lower shear generated when unwinding the roll on the roll holder.

Alternatively, the active ingredient could be added internally to the core after it is formed by spraying it from the sides of the core, which are open. However, cores are normally about 100 inches long and modern commercial core winders can produce about 50 to 70 cores/min. As such, if the product is sprayed only from the sides, the spray pattern would be non-uniform due to the length of the core, resulting in most of the ingredient being applied to the ends of the core. After the tissue product is wound on the core to form a log and then the log is further cut into shorter individual rolls, typically about 4 inches for bath tissue rolls and 11 inches for paper towel rolls, only the rolls cut from the ends of the log would have a sufficient concentration of the active ingredient. Additionally, with the high speed of production of about 1 core per second, it would not be viable to insert nozzles into one or both ends of the finished cores, spray uniformly, and then retract the nozzles in time.

In order to spray microcapsules uniformly and efficiently on the interior of a core without risking their rupture during manufacturing, the present inventor designed the apparatus described herein, in which a fluid dispensing unit, such as a nozzle, is placed on the end of the winding mandrel. To supply the dispensing unit with the fluid, one or more pipes can be run through the interior of the mandrel and connect to liquid and/or compressed gas reservoirs. Since the mandrel is typically fixed, it is relatively simple to run the piping through it.

Advantageously, the spray pattern can be highly uniform across the interior of the core. For example, if a nozzle with a conical spray pattern is used, the fluid is applied in a uniform ring as the tube passes over the nozzle. To control the concentration, the flow rate of the fluid dispensed and the linear speed of the tube traveling over the mandrel can be controlled as desired. For example, to maintain uniformity, if the linear speed of tube production is doubled, the flow rate through the dispensing unit would also need to be doubled. The spraying operation does not need to be synchronized with any downstream cutting operations, as the cut occurs far enough downstream that the core is essentially an infinitely long continuous tube as it passes over the dispensing unit.

As an additional advantage, the active ingredient is contained within the interior of the tube being produced and thus the risk of any environmental contamination from the active ingredient is reduced. In order to prevent spraying into the environment when production is interrupted, the spraying operation can be synchronized with the machine speed. Further, in one embodiment, a sensor is provided to monitor the process for any stopping in operation or any break in the tube. The sensor can send a signal to a controller which can stop the spraying operation.

While the apparatus is particularly useful for dispensing microcapsules on the interior of the tube, it also provides advantages when applying other active ingredients to the tube. For example, some ingredients can be effectively applied to either the interior or exterior of the tube. Spraying externally to the tube would require multiple nozzles, would waste active ingredient that is sprayed into the surrounding environment, would be a messy process, and would make it difficult to provide uniform coverage. However, the apparatus and process described herein allows for uniform coverage on the interior of the tube using a single dispensing unit and prevents the waste and mess that would occur in an external spray system.

The active ingredient can be any active ingredient that would be beneficial to apply to a core of a paper product. For example, as described above, the active ingredient can be a fragrance. However, it can also be another odor control substance, an essential oil, a tube strengthening agent, a lubricant, or an antimicrobial compound.

Suitable odor control ingredients include, but are not limited to, zinc salts; talc powder; encapsulated fragrances (including microcapsules and fragrances encapsulated in liposomes, vessicles, or microemulsions); chelants, such as ethylenediamine tetra-acetic acid; zeolites; activated silica or activated carbon granules or fibers; polycarboxylic acids, such as citric acid; cyclodextrins and cyclodextrin derivatives; chitosan or chitin and derivatives thereof; oxidizing agents; antimicrobial agents, including silver-loaded zeolites, cetyl pyridinium chloride, zinc chloride, copper salts, copper ions, chlorhexidine, quaternary ammonium compounds, parabens, and the like; triclosan; kieselguhr; and mixtures thereof.

Exemplary oils and extracts include, but are not limited to, those derived from the following plants: almond, amyris, anise, armoise, bergamot, cabreuva, calendula, canaga, cedar, chamomile, coconut, eucalyptus, fennel, jasmine, juniper, lavender, lemon, orange, palm, peppermint, quassia, rosemary, thyme, and the like.

As explained above, the apparatus provides particular advantages when the active ingredient is encapsulated in a microcapsule. However, the apparatus is capable of applying any fluid to the interior of a core. As such, the active ingredient can also simply be a liquid substance, a solid substance in a liquid carrier, or an aerosolized substance.

Microencapsulated active ingredients are known in the art and are not limited to any particular type. As one example, polymeric microcapsules having a polymeric coating which forms a shell around an oil-soluble core, which contains one or more active ingredients can be used. Exemplary microcapsules are described in U.S. Patent Application Publication Nos. 2004/0266302 and 2014/0187469, U.S. Pat. No. 10,722,857, and PCT Publication WO 2022/118008 A1, all of which are incorporated herein by reference.

In one aspect, microcapsules encapsulate the active ingredient and upon shearing or rupturing the microcapsule, one or more openings are created in the surface of the microcapsule through which the active ingredient will escape. Microcapsules are typically applied in a formulation containing a carrier. For example, typically microcapsules are applied in a suspension that is at least about 50 wt. % water, in some embodiments at least about 60 wt. % water, and in some embodiments, at least about 70 wt. % water. When the aqueous portion of the formulation evaporates from the core upon drying, the microcapsules are left behind.

In some embodiments, the formulation containing the microcapsules also contains a binder or adhesive which can enhance the adhesion of the microcapsules to the paperboard forming the core. Any suitable adhesive can be used. For example, urethane resins, polyolefin resins, halogenated resins, polyvinyl acetates, vinyl chloride-vinyl acetate copolymers, or the like can be included in the microcapsule formulation to enhance adhesion of the microcapsules to the core. When employed, binders or adhesives typically constitute less than about 20 wt. % of the formulation, in some embodiments less than about 10 wt. % of the formulation, and in some embodiments, less than about 5 wt. % of the formulation.

In any case, the active ingredient is typically applied to the core in a concentration from about 0.1 to about 100 g/m², in some embodiments from about 0.2 to about 50 g/m², in some embodiments, from about 0.4 to about 20 g/m², and in some embodiments, from about 2 to about 12 g/m².

As explained above, the fluid containing the active ingredient can be stored in a reservoir that is connected to the dispensing unit through a pipe in the mandrel. The reservoir can be any tank or vessel suitable for holding the fluid.

Preferably the active ingredient is a liquid or is a solid contained in a liquid carrier. In the case of microcapsules, the active ingredient is preferably liquid encapsulated in a solid, which is in turn suspended in a liquid carrier. The liquid can be pumped from the reservoir to the pipe and eventually to the dispensing unit using any suitable pump. For example, the pump can be a centrifugal pump, such as an axial flow pump, radial flow pump, or mixed flow pump, or a positive displacement pump, such as a reciprocating pump or a rotary pump.

In some embodiments, the dispensing unit is also connected to a compressed gas reservoir, which can atomize or aerosolize the active ingredient. The compressed gas can include any inert gas but is preferably compressed air from a compressor. The compressed gas pressure and liquid flowrate can be controlled as is known in the art in order to achieve the desired concentration of active ingredient on the core. In one embodiment, the compressed gas and the liquid are kept in separate reservoirs and travel through the mandrel in separate pipes until they reach the dispensing unit, where the compressed gas is used to propel the liquid as an aerosol.

In some embodiments, no compressed air is used, and the liquid is sprayed onto the interior of the tube using only the force generated by the pump forcing the liquid through a nozzle with a suitable spray pattern, such as a conical misting spray pattern to achieve optimal uniformity.

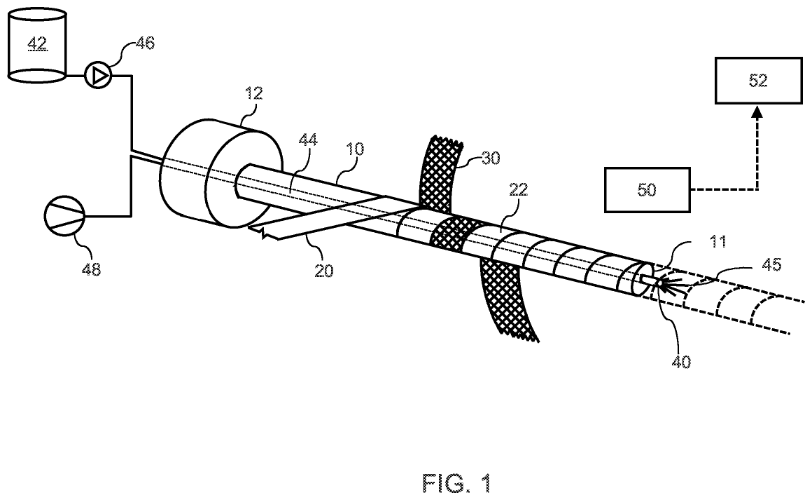

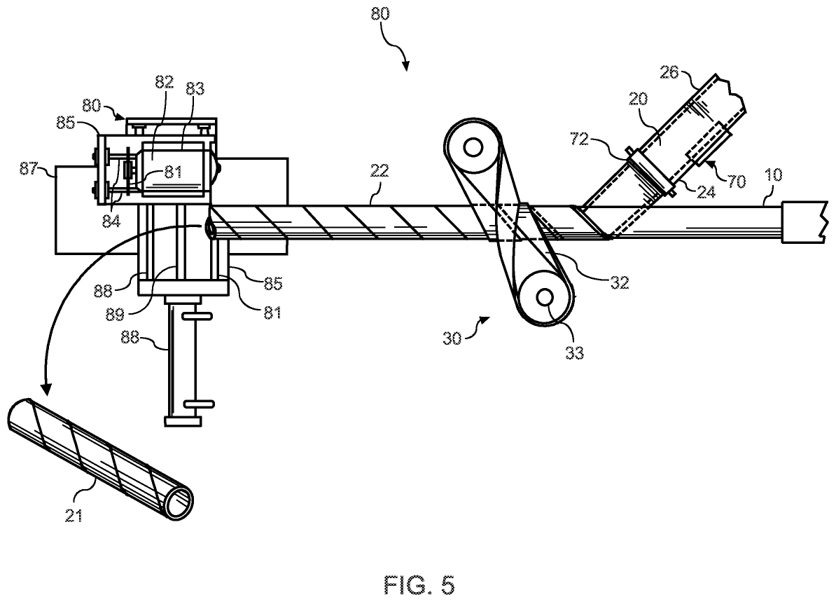

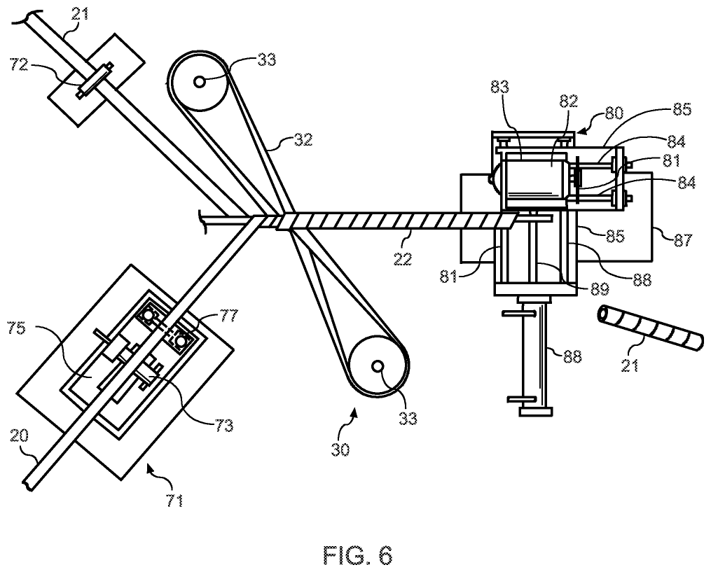

One embodiment of the apparatus is illustrated by FIG. 1. FIG. 1 shows a mandrel 10 cantilevered from a support 12. The mandrel 10 is preferably fixed to the support 12 such that it cannot rotate, however, it is possible to mount it rotatably to the support. A strip of a web material 20 is shown being fed to the winding mandrel 10 and being wound around the mandrel by a winding belt 30. The winding belt is part of a winding unit better illustrated by FIGS. 5 and 6. As shown in FIG. 1, the winding belt 30 is looped around the mandrel 10 and a portion of the web strip 20. The web strip 20 is fed at an angle to the mandrel 10 such that, as it passes through the winding belt 30, it is wound around the mandrel 10 in a spiral manner to form a tube 22 on the mandrel 10 downstream from the winding belt 30. The force exerted by the winding belt 30 causes the angled web strip 20 to be advanced along the fixed mandrel 10 toward a distal end 11 of the mandrel 10.

An adhesive is applied to the web strip to hold the tube together, preventing the strip of web material from unwinding after it advances past the winding belt. In one embodiment, the tube can be formed from a single strip of web material. When only one strip is used, the angle of the feed is controlled such that the leading edge of the strip of web material being fed to the mandrel overlaps with the trialing edge of the same strip that has already been wound around the mandrel. In such an embodiment, the adhesive is preferably applied only to either the upper surface of the trailing edge or the bottom surface of the trailing edge so that it will be contained in the overlapping portion.

Alternatively, the web can be formed from multiple strips of web material. Each strip can be fed from the same side of the mandrel, or at least one strip can be fed from the opposite side from the other(s). When multiple strips are used, they should be aligned in a staggered manner such that each strip does not overlap with itself and such that the seams between the leading and trailing edges of each layer do not align with the seams of the adjacent layer(s). When multiple strips are used to form the tube, the adhesive can be applied to the entire underside of the top layer and any other layers except for the bottom layer contacting the mandrel. When three or more layers are used, the adhesive can be applied to one or both surfaces of the middle strips. Forming the tube with multiple layers can provide the tube with greater mechanical strength.

As shown in FIG. 1, a dispensing unit 40 is disposed at the distal end 11 of the winding mandrel 10, which is the end opposite the supported end. The dispensing unit can be any dispenser capable of dispensing a liquid onto the inner part of the tube travelling past the unit. For example, the dispensing unit can be a nozzle, valve, spigot, or the like. As shown in FIG. 1, a nozzle 40 is connected to a liquid reservoir 42 by a pipe 44. A pump 46 is provided to pump liquid from the liquid reservoir 42 to the nozzle 40. As explained above, the pipe 44 can also be connected to a gas supply, such as an air compressor or blower 48. Alternatively, the apparatus can include separate liquid and gas supply pipes which each supply the dispensing unit separately. Fluid 45 dispensed from the nozzle 40 is sprayed onto an interior surface of the tube 22.

A cutting operation can be performed downstream from the dispensing unit to cut the tube into cores.

In the embodiment shown in FIG. 1, the apparatus further includes a sensor 50 and a controller 52. The sensor can be any sensor capable of detecting an interruption in the tube forming process, such as a stoppage or a breakage in the tube. For example, the sensor can be a photocell sensor. The sensor is configured to send a signal to the controller, which can be transmitted by a wire between the controller and the sensor or can be transmitted wirelessly. The controller is configured to stop the spraying operation when the sensor detects an interruption in the tube forming operation, so as not to spray the fluid into the surrounding environment. For example, many known core forming machines include sensors to detect breakage of the tube. Such sensors can be used to communicate with the controller, which can stop the fluid dispensing process.

Additionally, the apparatus can include a cleaning mechanism for cleaning the dispensing unit and/or the inside of the tube. In one embodiment, the dispensing unit can be cleaned by an air stream. For example, if the apparatus includes a compressed air supply line through the pipe, the air can be supplied to the dispensing unit without the liquid in order to clean the dispensing unit and blow any dust or debris from the inside of the tube. The air can be supplied through a line the feeds the dispensing unit directly or the air can be supplied to the opening of the pipe 44 at the supported end of the mandrel. Alternatively, air can be blown at the nozzle from a point external to the mandrel. For example, air can be blown at the dispensing unit without traveling through pipe 44. For instance, the air can be blown from the compressor or blower 48 through a second pipe external to the mandrel or from a separate compressor or blower, which can be located closer to the dispensing unit.

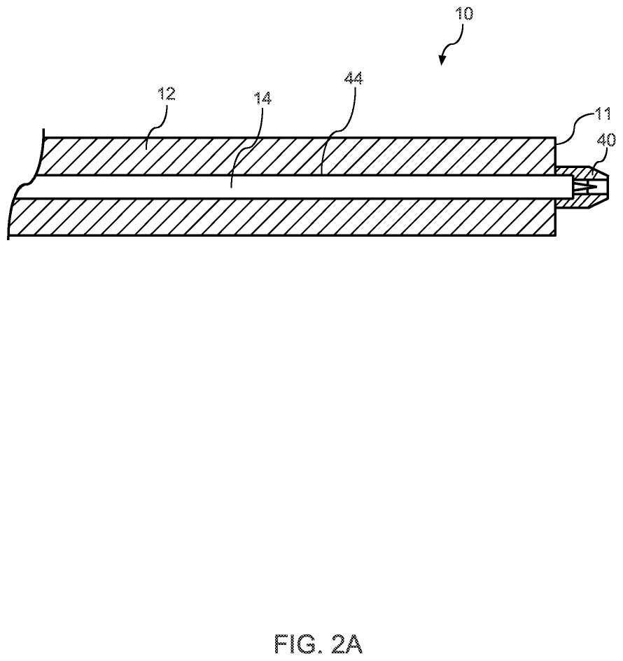

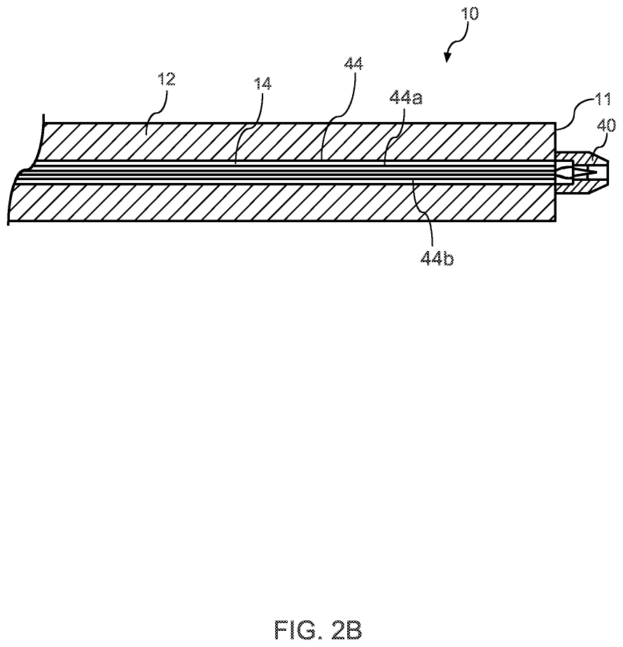

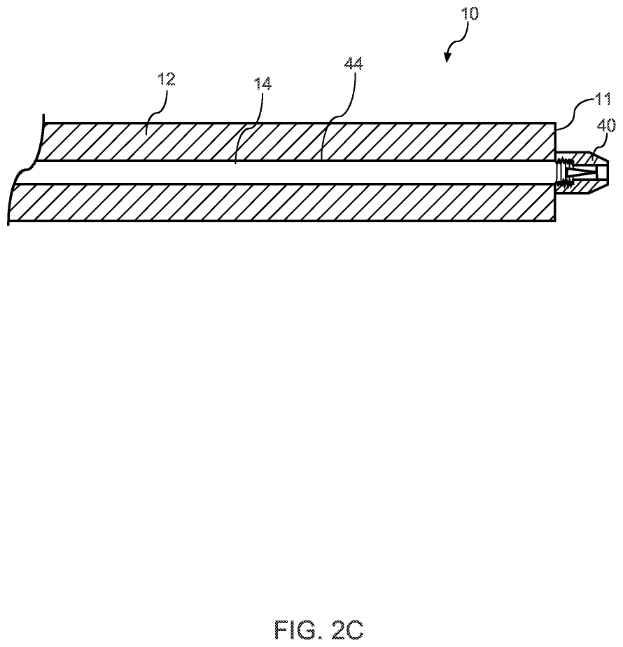

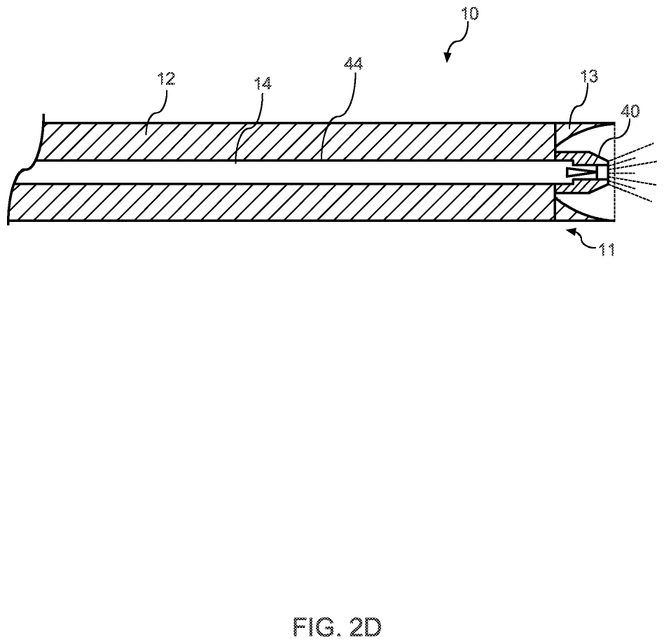

FIGS. 2a-2d show a cross section of one embodiment of the mandrel 10 and a nozzle 40. The mandrel 10 comprises an annular wall 12 which surrounds a hollow center 14. As shown in FIG. 2a, in one embodiment, the inner surface of the annular wall 12 forms the outer wall of the pipe 44. Alternatively, as shown in FIG. 2b, smaller individual pipes or tubes 44a and 44b can be routed through the hollow center 14. A nozzle 40 is disposed at the distal end of the mandrel. In one embodiment, shown in FIG. 2a, the nozzle 40 can be integral with the mandrel 10. In another embodiment, shown in FIG. 2c, the nozzle can be a separate component from the mandrel and can be secured to the distal end by any suitable means. For example, as shown in FIG. 2c, the end of the pipe 44 can be threaded and a nozzle 40 can be attached via corresponding threading. It should be noted that while FIG. 2c shows only a single pipe leading to the nozzle, multiple pipes can be connected to the nozzle as well.

The dispensing unit 40 is preferably located close to the distal end 11 of the mandrel 10 and preferably projects minimally from it in order to best protect the dispensing unit from any possible damage or contamination from the rest of the winding process. In one embodiment, as shown in FIG. 2d, the distal end 11 of the mandrel 10 includes a protective shroud 13 extending from the annular wall 12 that covers the dispensing unit 40. In such an embodiment, the spray angle should be such that the shroud covers the nozzle but does not interfere with the spray pattern.

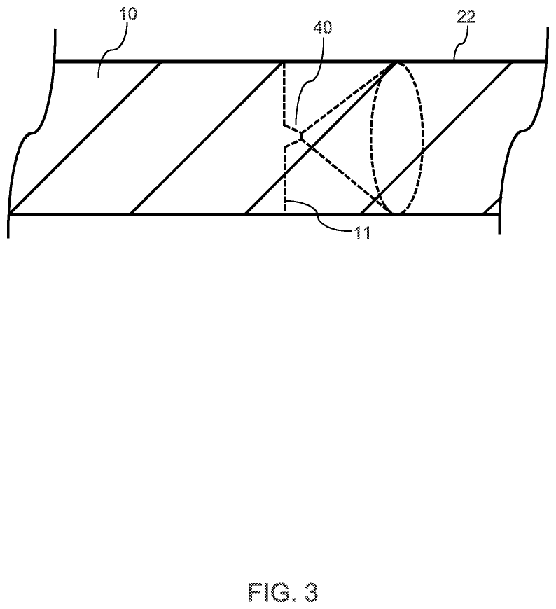

FIG. 3 shows an embodiment of a nozzle 40 spraying the inside of a tube 22. The tube is driven by the winding unit over the mandrel 10 and is sprayed uniformly with a fluid dispensed by the nozzle 40 as the tube 22 passes over it. FIG. 3 shows a hollow conical spray pattern which is ideal for obtaining a uniform covering by the active ingredient. Alternatively, the nozzle can simply spray the fluid in a full cone pattern. However, in other embodiments, the fluid dispensing unit may comprise a plurality of nozzles which combine to spray a uniform pattern on the tube. For example, in one embodiment, a first nozzle can spray a 180 degree fan pattern or a half cone pattern on the upper portion of the tube interior and a second nozzle can spray a 180 degree fan pattern or a half cone pattern on the lower portion of the tube interior. Of course, while a uniform covering of the interior of the tube is preferred, it should be understood that the spray pattern is not limited and there may be circumstances where a non-uniform spray pattern could be employed.

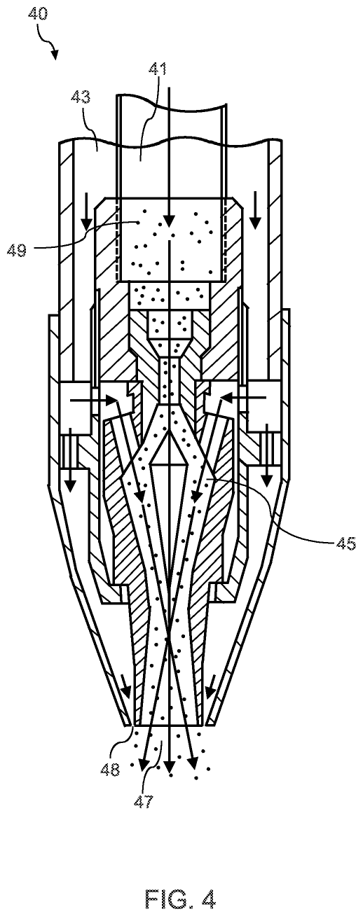

One embodiment of a nozzle which can be used as the fluid dispensing unit is illustrated in FIG. 4. The nozzle 40 is a two-phase nozzle designed to atomize a liquid containing solids 49 dispersed therein. The nozzle contains a central liquid supply port 41 and an annular gas supply port 43. The liquid and gas phases are combined in a mixing chamber 45 and the combined contents are ejected through the fluid outlet 47. Additionally, the nozzle contains a peripheral gas outlet 48 where pressurized gas that does not enter the mixing chamber 45 is ejected. It should be noted that the nozzle is not limited and any nozzle suitable for dispersing a fluid can be used. For example, U.S. Pat. No. 8,590,812, which is incorporated herein by reference, provides nozzles suitable for two phase distribution of liquids containing solids dispersed therein.

The winding and cutting units of the apparatus are best shown in FIGS. 5 and 6. FIG. 5 shows an embodiment wherein the core is formed from a single layer of web material. FIG. 6 shows an embodiment wherein the core is formed from two layers of web material. In FIG. 5, a strip of web material 20 passes through an adhesive applicator 70, which applies a layer of adhesive to the outer surface of the web's trailing edge 24. From the adhesive applicator 70, the web strip 20 then passes to a lubricator 72, which applies a lubricant to the inner surface of the web strip 20, which reduces friction between the inner surface of the tube 22 and the mandrel 10 to facilitate the tube 22 sliding over the mandrel 10. The web strip 20 is then spirally wound onto the mandrel 10 to form the tube 22.

In one embodiment, the winding unit 30 comprises an endless winding belt 32, which rotates the tube 22 as it is formed on the mandrel 10 and thus pulls the web strip 20 onto the mandrel 10 as is well known in the art. The winding belt 32 is looped at each end about a drive pulley 33 driven by a motor. The web strip 20 is oriented so that its inner surface overlies the mandrel and so that the trailing edge portion 24 of the strip is overlapped by the adjacent leading edge 26 of the strip. The adhesive layer located on the outer surface of the trailing edge portion 24 contacts and adheres to the inner surface of the leading edge 26 of the ply in edge-overlapping relation. As the tube 22 is conveyed along the mandrel 10, the adhesive between the overlapped faces of the edges of the web dries so that the overlapped joint is formed. The tube 22 is cut into shorter cores 21 of a desired length by a cutting unit 80. Of course, the embodiment described is only one example and the winding unit employed can be any unit suitable for winding a paperboard strip about a mandrel.

The cutting unit 80 can take any suitable form. In the example shown in FIGS. 5 and 6, a cutting blade 81 is rotatably driven by a motor 82 secured to a movable base 83. The movable base 83 is mounted for simultaneous reciprocation in mutually orthogonal directions in timed relation with the velocity of the formed tube 22 being discharged from the mandrel 10. The base 83 is reciprocated (by means not shown) longitudinally, that is, in a direction parallel to the mandrel 10, along guide rods 84 mounted on a carriage 85. The carriage 85, in turn, is mounted for lateral reciprocation, that is, in a direction perpendicular to the mandrel axis, along guide rods carried by a fixed base 87. Movement of the carriage 85 is provided by hydraulic cylinder/piston means 88 having a piston rod 89 extending therefrom and connected to the carriage 85. The cutting operation is performed when the carriage 85 is drawn laterally to move the cutting blade 81 across the path of the tube being discharged from the mandrel 10, while simultaneously being moved longitudinally at the velocity of the discharging tube stock so that a straight cut results. Other types of tube cutters, including gang cutters capable of severing a plurality of tube lengths simultaneously, can also be used.

FIG. 6 shows an embodiment of a core forming apparatus which forms a core from two strips of web material. The apparatus is similar to the one shown in

FIG. 5 in many ways. However, as shown in FIG. 6, a second web strip 21 is fed from the opposite side of the mandrel from web strip 20. Additionally, instead of the leading edge overlapping with the trailing edge at the seams as shown in FIG. 5, the edges preferably do not overlap with the edges on the same layer. Instead, the strip of web 21 is offset from the strip of web 20 such that the seams of each layer are staggered.

Additionally, when more than one strip is used, the adhesive can be applied to the entire underside of the outer layer rather than just the trailing edge. For example, FIG. 6 shows an adhesive applicator 71 which comprises a roller 73, an adhesive reservoir 75, and a doctor blade 77. Web strip 20 is passed over the roller 73, the bottom of which is submerged in the adhesive reservoir 75. As such, as the roller 73 is rotated, it picks up adhesive from the reservoir and applies it to the web strip 20. The web strip 20 is then passed over the doctor blade 77 which removes excess adhesive.

The strip of web material can be a paperboard ply of various densities and basis weights. For example, in some embodiments, the basis weight is up to about 500 gsm, and the ply is preferably a relatively low density ply having a basis weight of between about 150 and about 350 gsm.

The adhesive applied to the web material can be any suitable permanent adhesive that does not fracture or peel off during ordinary use. Suitable permanent adhesives include well known aqueous based resin adhesives, such as polyvinyl acetate resin adhesives. Any lubricant suitable for use with paperboard materials can be used. Preferably the lubricant is a solid organic lubricant, for example, hydrocarbon derivatives such as paraffin waxes and the like or animal or vegetable fats. The lubricant can be applied to the web by contacting the surface of the web with the solid lubricant, for example, by running the ply over a block containing the lubricant.

Once the core is cut by the cutting unit, it can be placed onto a mandrel that is capable of spinning so that the spinning of the mandrel in conjunction with the core can effectuate winding of a paper product thereon in a rewinder apparatus.

Techniques for utilizing mandrels for winding paper are generally well known in the art. For example, a turret-style winding system is one well-known method used to wind paper onto a core. Most turret systems include a number of mandrels that are each capable of spinning independently of each other so that multiple paper logs can be formed simultaneously. For example, in some conventional turret systems, a core is first loaded onto a mandrel. After loading, the mandrel and core can be spun so that a sheet of paper can be wound around the core. Once the desired amount of paper is wound onto the core, the core and paper can then be removed. The log roll can then be cut into finished rolls of the paper product.

Preferably, the cores are cut by the cutting unit to be the same length as the parent roll used in the rewinder, which is typically about 100 inches but can vary as known in the art. For example, in some embodiments, the core length can range from about 55 inches to about 220 inches.

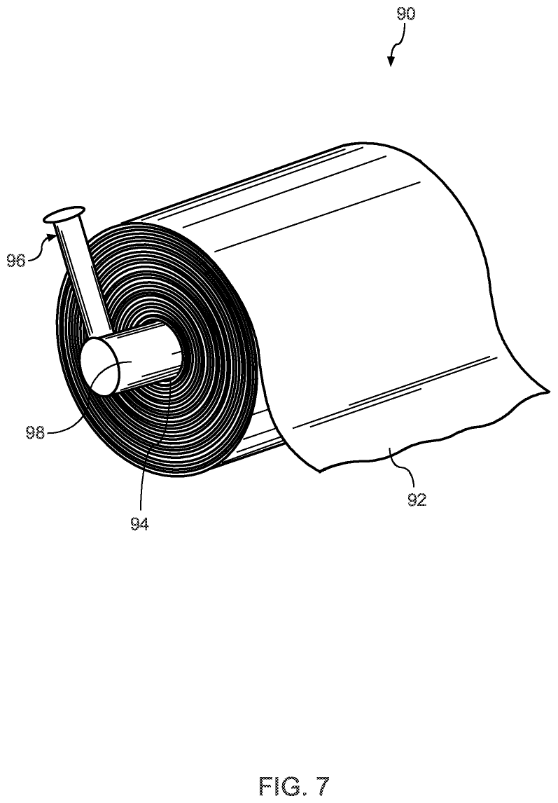

One embodiment of a tissue product made in accordance with the present disclosure is illustrated in FIG. 7. In particular, in FIG. 7, a bath tissue roll 90 is comprised of a tissue sheet 92 that has been spirally wound into a roll around a finished core 94. Microcapsules containing an active ingredient are dispersed about the inner surface of the finished core 94. The microcapsules can be ruptured by a roll holder 96 including a spindle 98 as the roll is rotated on the spindle.

If desired, the tissue sheet 92 of the bath tissue roll 90 can include perforation lines. The perforation lines, for instance, can run in a direction that is perpendicular to the length of the tissue sheet. The perforation lines can be present at regular intervals. Perforation lines make it easy for the user to tear off a desired piece or panel of the tissue sheet as it is dispensed from the roll. In addition to bath tissue rolls, the present disclosure can also be used to construct various other tissue products, such as paper towel rolls.

In general, the core has a diameter of at least about 0.5 inches, such as from about 0.5 inches to about 3 inches, such as from about 1 inch to about 3 inches. The core can be formed so as to have a substantially circular shape and can have a size suitable to accommodate a spindle.

Tissue sheets made in accordance with the present disclosure generally contain a substantial amount of pulp fiber. For instance, the tissue sheets, contain pulp fibers in the amount of at least about 50% by weight, such as an amount of at least 80% by weight. In one embodiment, for instance, the tissue sheets can consist essentially of pulp fibers.

Tissue rolls made in accordance with the present disclosure generally dispense dry products that only contain ambient amounts of moisture. The tissue sheets generally have a bulk of at least 3 cc/g, such as about 5 cc/g to about 15 cc/g. The tissue sheets can have a basis weight from about 8 gsm to about 85 gsm depending upon the particular application. For example, bath tissue generally has a basis weight of from about 8 gsm to about 45 gsm, such as about 15 gsm to about 35 gsm. Paper towels, napkins, industrial wipers, and the like, on the other hand, may have a basis weight of from about 25 gsm to about 100 gsm.

The tissue products of the present disclosure can generally be formed in any of a variety of tissue making processes known in the art. For instance, processes such as through-air drying, adhesive creping, wet creping, double creping, embossing, wet pressing, air pressing, and the like can be used in forming the tissue sheets.

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged either in whole or in part. Furthermore, those of ordinary skill in the art will appreciate that the foregoing description is by way of example only, and is not intended to limit the disclosure so further described in such appended claims.

1. An apparatus for producing tubes, the apparatus comprising:
a mandrel around which a tube is formed by winding at least one strip of web material, the at least one strip of web material comprising a paperboard ply;
a winding unit configured to wind the at least one strip of web material around the mandrel and to advance the tube along the mandrel toward a distal end of the mandrel; and
a fluid dispensing unit disposed at the distal end of the mandrel configured to dispense a fluid to an inner surface of the tube as it advances past the distal end of the mandrel.

2. The apparatus of claim 1, further comprising a cutting unit configured to cut the tube downstream of the fluid dispensing unit.

33. The apparatus of claim 1, wherein the fluid dispensing unit is a two-phase nozzle.

4. The apparatus of claim 1, wherein the fluid dispensing unit is configured to dispense the fluid in a conical pattern.

5. The apparatus of claim 1, further comprising at least one pipe running longitudinally through a hollow interior of the mandrel.

6. The apparatus of claim 5, wherein the at least one pipe connects a liquid reservoir to the fluid dispensing unit.

7. The apparatus of claim 5, wherein the at least one pipe connects a gas supply to the fluid dispensing unit.

8. The apparatus of claim 1, wherein the mandrel is fixed.

9. The apparatus of claim 1, wherein the apparatus further comprises a photocell sensor in communication with a controller configured to stop the operation of the fluid dispensing unit.

10. A system comprising the apparatus and fluid of claim 1.

11. The system of claim 10, wherein the fluid comprises a suspension of microcapsules.

12. The system of claim 11, wherein the microcapsules contain an active ingredient selected from the group consisting of a fragrance, an essential oil, an odor control agent, and an antimicrobial agent.

13. The system of claim 11, wherein the fluid is an aerosol containing the microcapsules.

14. The system of claim 10, wherein the fluid is a liquid suspension of microcapsules.

15. The system of claim 10, wherein the fluid comprises a liquid active ingredient.

16. The system of claim 15, wherein the liquid active ingredient comprises a fragrance, an essential oil, or an antimicrobial agent.

17. A process for forming a tube, the process comprising:
applying an adhesive to a strip of web material, the strip of web material comprising a paperboard ply;
winding the strip of web material onto a mandrel in a spiral configuration to form a tube extending along the mandrel;
causing the tube to advance along the mandrel toward a distal end of the mandrel; and
applying a fluid to an inner surface of the tube by a fluid dispensing unit disposed at the distal end of the mandrel.

18. The process of claim 17, further comprising cutting the tube in a downstream direction from the fluid dispensing unit to form a core.

19. The process of claim 18, further comprising winding a paper product onto the core.

21. (canceled)

22. (canceled)

23. (canceled)

24. (canceled)

25. (canceled)

26. (canceled)

27. (canceled)

28. (canceled)

29. (canceled)

30. A spirally wound tube comprising at least one paperboard ply wound in a spiral manner to form the tube and an active ingredient applied to the inner surface of the tube.

31. (canceled)

32. (canceled)
